(19) United States
(12) Patent Application Publication
(10) Pub. No.: US 2010/0023434 A1
(43) Pub. Date: Jan. 28, 2010

(54) Automated Credit/Debt Management Counsel By Isaiah Bond

(76) Inventor: ISAIAH BOND, Harrison, NY (US)

Correspondence Address: ISAIAH BOND, 257 CONDIT STREET, HARRISON, NY, 10528, US

(21) Appl. No.: 12/180,546

(22) Filed: Jul. 27, 2008

(51) Int. Cl. G06Q 40/00

(52) U.S. Cl. 705/35

(57) ABSTRACT

The present invention combines automated consulting with live advising within the framework of an online, web-enabled automated credit/debt management counseling and modeling system. An automated coach alerts and focuses the user's attention to the issues to be addressed, and frames decisions to be made with general information on each topic based off of technical calculations in relations to the credit/debt management history analyzed. A live advisor supplies specific, innovative solutions based on the user's unique credit/debt situation as an aid for the results of the computer automated system.

The present invention relates to a web-based credit/debt management system for providing personalized credit/debt management automated/live consulting to a user. The system operates in a collaborative computing environment between the user and automated consultant. User will be equipped with an individual user id and password and be asked to electronically sign an agreement with said company to avoid legal matters and ensure security.

A risk evaluator will structure the users credit portfolio, it will calculate based off of the current credit report and the users answer on the questionnaire the time frame it will most likely take for the users credit grade to reach its maximum potential in a max of a 4 year period for credit scoring engine range and then after 30 years for debt management range later calculated based off of a monthly chart that reviews derogatory type and based off credit general statistics on “turn around” time for each credit topic that our system is customized to calculate. The system will also help the user to manage his/her portfolio and save documented files issued to bureaus to easily retrieve via an import link to pc or an automated barcode routed e-fax number, the system will continue to re-pull credit data and continue to advise until he/she reach their desired level of risk tolerance and credit grade based on the package of choice. The system will have a unique one of a kind risk evaluating module that we have developed which will state the users credit/debt management health based on grade levels (A, B, C, D, F).

To follow this process will be a credit/debt management automated software which comprises an advice generating subsystem. The automated coaching consultant provides automated customized credit/debt management advice custom tailored to the user's credit/debt management intentions and time frame needed to improve credibility or eliminate debt while still maintaining good credit stature over a 30 year period. The present invention also provides a third party public monitoring database issued by credit vendors of our choice that provide the users credit report that we submit into our portfolio management subsystem enabling our system to review the credit report and automatically identify by file format and user consent (.txt, .pdf or any format able to scan data) and encrypted programming codes (detailed below) which focus on the particular areas that the user shows weak and high risk levels in relations to credit and debt. The program will then ask the user a series of questions about the derogatory topics it identified with extensive advice on how these items can be removed if inaccurately placed there or how the debts can be reduced at a quicker pace or settled, etc. After the series of questions are asked to the user any answers encountered on his/her questionnaire will be collected targeting disputes and formatting them into a detailed letter with all the user's information that the user may print out and sign or review and save. It will also include a basic check list of information based off of the credit analysis to determine what else the user would need to include in his/her dispute package to rectify the issues being reported e.g a collection resolved would need a receipt in order for the bureaus to remove. The user would then be responsible to print/electronically submit if applicable with current laws their signature on letter head accompanying all documents needed from bureaus. If items are disputed we will have an additional section that requests the users to answer various questions in relations to the items that have been disputed by the creditor and directed back to them for response with advice on how to handle the situation after our questionnaire has been completed. If our system feels a law has been violated we will have a list of outgoing staff available to make phone calls/have the user write automated letters to individual creditors to resolve debts/credit errors if necessary verbally or if we feel after a live advisory/30 day dispute with creditors this method is not appropriate/effective we will provide the user with affiliated fair credit reporting act attorneys that will represent the user to bring each creditor/bureau to court to officially resolve this matter and collect damages to ensure a stable society and to prevent violations of the Fair Credit Reporting Act law. The user will have the option to use our identity monitoring/theft prevention and on a daily basis that will be offered by a third party vendor & our automated risk evaluator model and be allowed to reuse our credit/debt management automated counsel software after a 31 day period to ensure we comply with necessary law allowance in dispute resolution. The system will supply its own credit & debt health module that is based on daily analysis of professional credit examiners in their everyday actions in the counseling of credit improvement and debt management as changes update our system will update its methods along with new underwriter guidelines and popular credit scoring engine guidelines and eventually assist the user in reaching their goal and helping them avoid this credit dilemma that is drawing a great impact on our economy and sending more people every day into bankruptcy or foreclosure. The system will read topics such as (credit card balances over 30% of the maximum allowed balance, a debt that is predicted to expire in the next for example 30 years and explain to the user with additional payments per month how to reduce the interest being charged by paying higher principal balances with a chart based on the users realistic affordability barriers on how much they can afford to pay per month which will be analyzed and branched off into different user accounts to calculate the most effective and cost saving method to eventually deplete all debts and maintain a good credit stature along with showing the user the amount of money saved to influence them to take the systems advice. A module that can calculate and read the maximum debt balance verse the current debt balance and determine the percentage and whether it is over the impact margin of 30% or under verse credit cards and so on and so forth for different items reflecting different categories of debt. Identify public record data such as foreclosure, bankruptcy, general lien, court orders, judgments, debts/any balance that reads due under public records; the system will calculate the date reported and determine if to date for each category of the public record derogatory based on the type whether it has passed the statute of limitation on reporting and how long it will have an impact on the user applying for a credit type (real estate, revolving (credit card, charge account, credit line) installment (auto, personal, student, business loan or general loan where it does not revolve), other (collection or debt due immediate since it does not state revolving nor show term). Each derogatory traced shall be collected and shall be a part of the questionnaire the user will be interrogated on. The system will be programmed to locate derogatory items based off of a late reporting as 30, 60, 90+, debt reporting due, closed by creditor and past due, past due, showing closed with open balances, inquiries that read on report, public records, open balances, address information verification, no credit history, or less than two trade lines opened for less than two years, amount of trade lines opened in a 3 month period, the amount of new credit opened in a 3 month period that is over a certain ratio verse current debt, etc. The questionnaire will ask the user questions about the validity of the debt, and based on the users answer/age of debt coach the user on ways to remove the negative, dispute, settle or idealistically to resolve the debt from hurting the users credibility. Example: Foreclosure; It will notify the user how long it believes it will take before the credit health loses the massive amount of impact it has taken since the foreclosure occurred 3 years ago by determining the credit health after that 3 year mark whether by opinion in scoring modules used by major credit vendors or in general manual underwrite impact. Most conventional mortgage lenders will not review your foreclosure in their granting decision if your foreclosure has taken place 3 or more years ago and then issue a grade the system determines suitable which will give the user a close range of where the popular credit scoring engines may depict; and repeat the same process in qualification on underwriting guidelines in different topics (credit card, auto loan, student loan, installment, revolving) with different time frames based on the current market guidelines and terms of credibility. Along with a reminder alert to alert the user of any open accounts that reports on credit data we have on file to pay their bills before it impacts their credit score via email the 8th of the month with a list of accounts that are to be paid that are currently listed open to the systems knowledge per user only showing last 4 digits of account for security purposes and no personal information about the user sent via electronic mail. The system at the users consent will automatically review and update improvements, negatives, any new information reported to the users current credit file based on the monitoring of credit initialized every month/at the users sole discretion.

### DESCRIPTION

A computer program embodied on a computer readable medium for providing a web-based, online personalized credit/debt management counseling over the Internet in a collaborative computing environment, wherein the computer program comprises executable code for: determining the users credit profile and developing a service level agreement with a user which includes a desired service including: providing a plurality of unique service levels each including a unique combination of available computer consulting and live consulting, the live consulting being performed by a credit/debt management advisor; prompting a user to input personal information; receiving the users desired level of credit/debt management goals and from the plurality of available unique service levels and information determining the estimated date the user will reach this goal; estimating risk level to obtain credit based on the credit information; and negotiating fees to be charged to the user based upon estimating the desired level of service prior to providing services under the service agreement; analyzing, with the services provided by the service level, the credit/debt management needs of the user according to the credit/debt management information of the user, including processing the user's intended credit/debt management state, analyzing the user's credit portfolio, calculating the user's future credit grade (potential and factoring in risk events that may prevent the user from reaching this goal (example. late on mortgage); providing the automated credit/debt management advisor with the personal credit/debt management information and analysis of the needs of the user; detailing areas that require attention and grading them based on common practice of judging negative from positive; developing a credit model for the user to address the credit/debt management needs of the user by utilizing the computer consulting and the live consulting including permitting the user to enter a dialogue with at least one of a computer-generated consultant and the risk evaluator over the Internet as determined by the service level agreement, and permitting the user to initiate communication with the automated credit/debt management advisor to obtain advice and live consulting during the computer consulting dialogue; and generating a credit model for the user to implement computer coaching and live coaching as determined by the service level agreement.

### FIELD OF THE INVENTION

The present invention relates generally to automated computerized information systems and more particularly to automated web enabled computer implemented credit/debt management counseling systems.

### BACKGROUND OF THE INVENTION

Credit/debt management inspired individuals develop credit/debt management plans that help them achieve their ultimate personal/financial goals. Traditionally, many of these individuals have entrusted their credit/debt management plans to personal credit specialist or debt consolidation advisors who charge very high services fees and do not perform as well as they should since they usually try to limit the cooperative labor time realistically needed by the user to improve certain items.

More recently, however, some individuals have increasingly relied upon expensive credit/debt management consultants non-computer based providing simple general non-direct letters on letter heads with instructions on how the client is to fill out any of such without walking client through process step to step and then individualizing the situation through live coaching that have been very costly and in some cases against the fair credit reporting act since these live coaches would usually take care of client affairs and communicate with creditors direct on behalf of the client without verbal/written consent. However, these systems tend to focus on the administrative aspects of credit/debt management planning & counseling without enabling the user to understand what is being improved and making independent choices about their credit/debt goals and more or less influencing them through their own general or practiced methods which is illegal since the dispute was influenced in regards to falsify evidence to improve users credit data which costs a lot of creditor money in file review and in the end puts the user in the same boat only a couple of hundred dollars short of net worth. Furthermore, these systems are limited by their inability to dynamically analyze the credit/debt management goals and handle a large volume of clientele; although the live coaching may in return meet the consumer's guidelines; it is handled by humans solely and human errors are prone to occur which can create lawsuits and credit issues that the market has faced during the mortgage meltdown due to creditors/consumers being poorly advised on credit/debt management risk health levels. These limitations are counterproductive to the user's needs to develop and manage an integrated personal credit/debt management plan and help the user truly reach his/her credit/debt management goals which can take up to 3 years in certain circumstances from an executive decision-making perspective. This system will save the user an extraordinary amount of money in debt/credit consulting fees since it is computerized and has a flat rate fee verse live consultants who charge by the hour for 3 years worth of credit/debt management which would produce astronomical fees.

Many existing credit/debt management systems allow users to electronically organize their financial assets and liabilities but none currently actually help manage individual accounts and target data together on information on how to resolve the matter to the users discretion along with individualizing derogatory data and then managing the accounts until they have been satisfied with a monitoring system that will alert the users if any new information has been noted on their credit report. Along with a reminder alert to all user accounts that reports reminders to pay their bills via email with a list of accounts that are to be paid that are currently listed open to the systems knowledge per user per month. There are no similar systems to this it is the first of its kind in structure. Furthermore, manual systems typically rely on the user to continually update their personal credit/debt management data which will cause the user time loss and aggravation and discourage them from achieving their goal since most people do not have time that is why they hire consultants but what they do not realize is without an automated system the consultant will have to be in direct contact with the user throughout the process which is limited to usually 2 months which is not the peak of the users credit grade potential and a lot more time of the consultant and user are needed. As a result, these systems are insufficient. Our data-driven calculators are capable of providing the user with meaningful credit/debt management consulting customized to their personal/financial intentions and expectations.

Similarly, some credit/debt management systems present a static view of the user's credit/debt management health. These systems typically require the user to provide the most current credit/debt management data relating to their credit/debt management status and will not automatically update improvements to the users current credit file. Consequently, this problem is further exacerbated by the fact that these systems demand a lot of typing and guessing when the user enters credit/debt management data and none in existence or patent automatically retrieve credit/debt management data and analyze with feedback results on individual topics nor are as user friendly as this computer system. This process is time-consuming and inefficient and does not promote an intuitive understanding of how complex credit/debt management variables interact to produce a sensible credit/debt management goal (to maintain and improve).

Another problem with many existing credit/debt management systems is that the user is typically limited to managing the transactional details of their credit/debt management data since no automated consultation is provided. In these systems the user is shielded from the planning and deciding aspects of developing their credit/debt management plan. Accordingly, the user learns very little from the process and remains heavily dependent on the system to provide an accurate summary of their credit/debt management health. These limitations further exacerbate the potential lack of trust inherent within the relationship between the user and the credit/debt management system and eventually draw the user away from using the product and arriving back to where they originally started off in need of more help.

Furthermore, many existing credit/debt management systems do not project an automated future value of the user's credit/debt management portfolio and do not provide an indication of the likelihood of achieving that value. Thus, the user is left without any real sense of how to compare one credit/debt management plan to another. Consequently, these systems fail to foster a deeper understanding of the risks and/or rewards associated with seasoned credit/debt management planning. Furthermore, the user is left to their own devices to interpret the projected results of the credit/debt management model and thus leaves him dependent on a live advisor to guide him on how to resolve various credit/debt management issues since the systems merely provide general forms in relations to the topic not individualizing the specific technical needs of each user.

On the other end, when users consult a credit/debt management advisor a major portion of their consultation time is spent on walking a user through setting up a credit/debt management plan. Only after the credit/debt management plan is set up and analyzed by the credit/debt management advisor they can then shift to possible problem areas. This process is time consuming, inefficient and hence very expensive. The same would apply to credit/debt management advisors helping customers with setting up an ideal portfolio, consistent with the customer's risk tolerance, debt management intentions and over all final goals in relations to the establishment of this portfolio. Again a great deal of the valuable and expensive advisors time is spent setting up a credit/debt management profile for the customer, where as he should be focusing on specific recommendations to achieve specific user goals based off of the automatic credit/debt management counselor.

Currently, no web-enabled system exists that dynamically incorporates all of the user's credit/debt management liabilities into an integrated summary of their health and then acts as a consultant to each liabilities needs assisting the user in the repair of any of such. Individuals do not want to focus on the transactional details of their credit/debt management information they rather focus on the results and the impact it triggers on their FICO™ score or other popular scoring engine with no knowledge of how to improve it. A credit/debt management consultation system is needed where the user is provided with an integrated detailed analysis of their credit/debt management health and is given personalized credit/debt management coaching tailored to their financial goals and intentions. Furthermore, since automated coaching cannot completely replace a live advisor's expertise, experience and innovation in devising specific solutions to the user's problems, access to both automated and live coaching is desirable and more affordable. Thus the use of a sole live advisor may only be feasible for individuals with high net worth. Furthermore, no existing web-based-system has combined the cost savings of an automated consultant with the expertise of a live consultant, promoting an inexpensive comprehensive credit/debt management modeling and counseling tool.

### SUMMARY OF THE INVENTION

The present invention combines automated coaching with live advising within the framework of an online, web-enabled credit/debt management counseling and modeling system. This allows a user to get the benefits of a live counselors expertise, and experience and as well as the convenience and cost savings of an automated coach. An automated coach alerts and focuses the user's attention to the issues to be addressed, and frames decisions to be made with general information on each topic based off of technical calculations in relations to time, number of account and negative items effecting any of such. A live advisor supplies specific, innovative solutions based on the user's unique credit/debt situation displayed as a result of the computer automated system. Automated coaching helps focus the user's attention on specific problems and the live advisor provides specific solutions to those problems. This makes a more efficient use of the time spent with the live advisor.

In general terms, the present invention relates to a credit/debt management counseling/management system for providing personalized credit/debt management advice to a user. The system operates in a collaborative web-based computing environment between the user and a credit/debt management advisor and comprises a service level subsystem and a coaching subsystem. The service level subsystem allows the user to negotiate a service level agreement that defines the user's desired level of support and limits access to user provided information. The advice generating subsystem is coupled to the service level subsystem and includes one or more coaching engines that dynamically analyzes; the credit/debt management needs of the user in accordance with the user's service level agreement. Furthermore, the coaching engine provides customized credit/debt management analysis tailored to the user's life intentions.

The present invention also provides for a computing system that integrates the components of a user's credit/debt management life into a more comprehensive model. The system comprises an intentions profile subsystem and an aggregated current modeling subsystem. The intentions profile subsystem captures the user's intentions in a dynamic and interactive computing environment. The aggregated modeling subsystem combines data from the intentions profile subsystem and retrieves data to create from the credit/debt management report provided via public data issued by selected credit vendor of choice whose eventual goal will be to reach the peak of the user's credit/debt management potential.

In an embodiment of the present invention, the quantity and kinds of services received by the user from the system is in part based on the service level agreement. The user negotiates a service level suitable for the user. The access to the type and quantity of data provided by the user is also limited by the service level agreement. Preferably, the user interacts with the system through a user specific web page environment, wherein the web page is customized to the user based on his credit model and the data provided.

In another embodiment of the present invention, the user's life intentions regarding credit/debt management risk levels will be captured in the Risk Evaluator Model. The model integrates and displays the user's intentions based on a complex array of statistics and questions the user was asked at the beginning of the application which estimates based off of current statistics and evaluation of derogatory risk factors via public data the potential the user has to branch off solely based off of the users credit/debt management experience reported on the credit data report. The Risk Evaluator Model cash flow model highlights potential problems in the future and helps focus the user and advisor's attention directly to these areas in need of attention. Furthermore, the Risk Evaluator Model may include a risk module that is able to determine the chances the user has of avoiding default based off of their late habit data being reviewed with careful compliance as to why the user was late and based off of the users answers to their excuse aiding in advice on how to avoid these trends. The risk modeling system can combine actuarial data along with the user's interactions to foster an intuitive understanding of the user's exposure to credit/debt management risk.

In all modeling systems of the present invention, the user is supported by an automated rule-based consulting system directing the user's attention to the possible credit/debt problems and suggesting areas to focus attention on. Furthermore, the user further has access to a live advisor for more specific credit/debt management advice. The access to the automated coaching and the live advisor is controlled in part by the service level agreement.

By providing both an automated consulting engine and access to a live advisor, the user can take advantage of the cost savings and convenience of an automated system as well as the full benefits of the expertise of a live credit/debt management consultant. By focusing the user's attention to specific problems areas, the user may take full advantage of users time with a live advisor by directly attacking the problem and spend unnecessary time identifying his/her problem and modeling his/her financial goals. All the information the live advisor needs has been formatted in a useful manner by the credit/debt management counseling and modeling system with the help of the automated coaching engine. These and other advantages of the present invention will be apparent upon a study of the following descriptions and drawings.

### BRIEF DESCRIPTION OF THE DRAWINGS

The foregoing and other aspects and advantages are better understood from the following detailed description of a preferred embodiment of the invention with reference to the drawings, in which:

FIG. 1 illustrates representative system architecture in accordance with a preferred embodiment;

FIG. 2 is a block diagram of a credit/debt management system;

FIG. 3 is a block diagram of a representative hardware environment in accordance with a preferred embodiment; that comprises the process of service level agreements and how they comply with the overall invention.

### DETAILED DESCRIPTION OF THE PREFERRED EMBODIMENTS

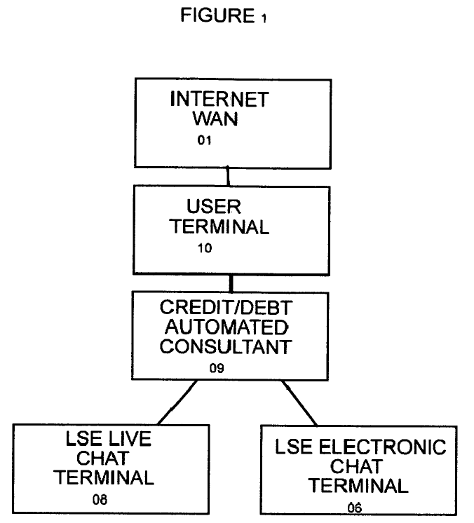

FIG. 1 is an illustration of one embodiment of a credit/debt management information system, in accordance with the present invention, for providing personalized credit/debt management coaching in a collaborative computing environment. In FIG. 1, credit/debt management system includes connected through a wide area network 01 to the user terminal 10 which connects to the live consultant electronic live chat terminal 06 live chat terminal 08 from the credit/debt management automated advisor system 09. The wide area network 01 of the present invention is the Internet. The Internet is based on the TCP/IP communication protocol first developed by the Department of Defense in the 1960s.

Preferably, the credit/debt management advisor system communicates with the user through any number of devices such as handheld wireless personal organizers, pagers, cellular telephones, land telephones, laptop, regular desktop computers or any data transmittal device that is scientifically capable of communicating with our program. All of the above equipment can act as a user terminal 10.

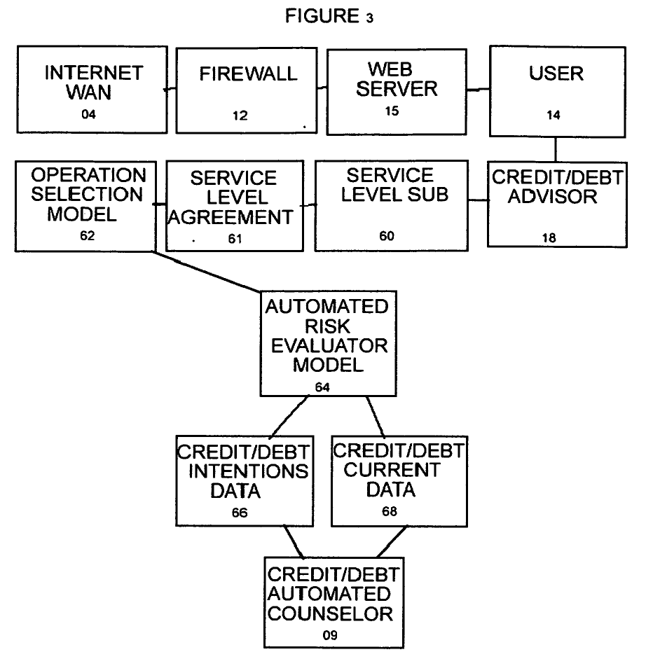

The user (e.g. individuals or company representative seeking credit/debt management advice) may access the system using a user terminal 10 (e.g. personal computer). A typical user computer terminal would be described in more detail in FIG. 3. Access to the live credit/debt management advisor 08 or 06 and all other services provided by the credit/debt management system is controlled and channeled through the credit/debt management automated advisor system 09. The user can access the credit/debt management advisor system 09 through the user network 10. A user electronic instant message system is transferred by the user to live advisor 06 or the user has the option to call the live advisor via live phone chat 08 with a password code the user must distribute to our live advisor for them to research the results of the users automated counseling session 09 which is issued after the credit/debt management automated counsel session.

The live electronic consultant chat terminal 06 is preferably equipped with electronic instant messaging capabilities. The live advisor 08 may further communicate with the user via a telephone.

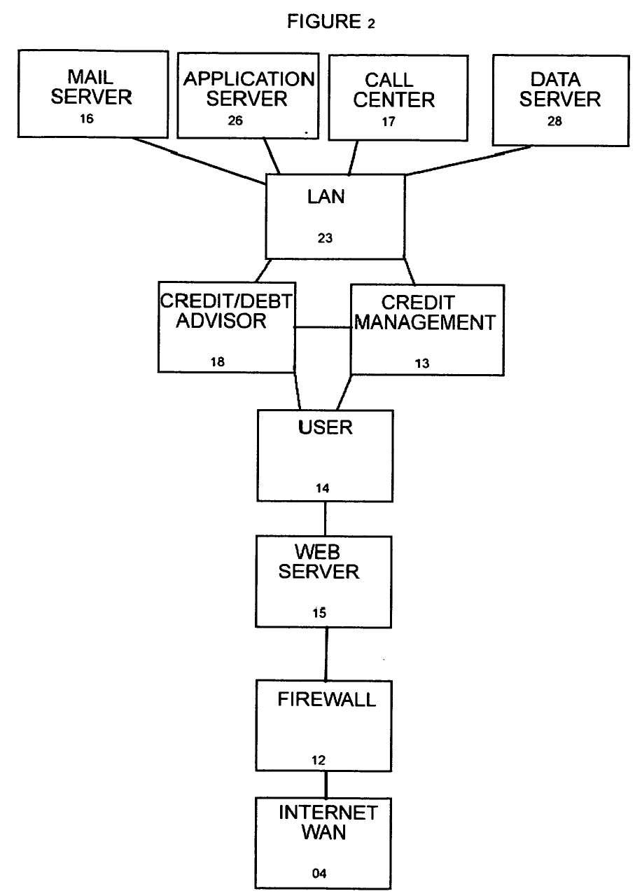

FIG. 2 is a block diagram of an implementation of the credit/debt management advisor system 18. The user may access the system through the wide area network 04 and through a firewall server 12. In a preferable implementation of the present invention, the wide area network is the Internet, an intranet, etc. A Web server 15 provides the user 14 with a personalized website providing an interactive interface between the user, the credit/debt management advisor 18 and credit/debt management system 13. The credit/debt management advisor system further comprises a mail server 16, an application server 26, a call center 17 and a data server 28, all interconnected through a local area network 23. The local area network (LAN) 23 may be any wide area intranet system or the internet.

Security is important in any credit/debt management system. The firewall server 12 controls the access to the credit/debt management advisor system. The purpose and functionality of a firewall server is to prevent access to the system by unauthorized users and it would be appreciated by one skilled in the arts. Firewall servers are available through a variety of vendors and have become a standard feature of any secure system used as the primary defense against intruders and hackers.

The web server 15 provides a personalized interactive web page environment for the user to operate in once he accesses the system. The web page is acting as the web interface between the credit/debt management system web pages may be created using the Hyper Text Markup Language (HTML), scripting languages such as the following programs Pearl™ Or Java Script™ as well as Java™ applets, Visual Basic, Cold Fusion, Asp.net, etc. Creation of customized web page using any of the above programming languages can be done properly by an experienced programmer. The personalized web page provides an environment and an interface for the user to interact with the credit/debt management advisor system. As an example, in one embodiment of the present invention, by selecting an appropriate icon from the interactive personalized website, the user is able to learn, plan, decide, transact and monitor his credit/debt management model.

The mail server 16 handles electronic mail communication between the user and the credit/debt management advisor system. The Mail server 16 may operate using any standard protocol such as Simple Mail Transfer Protocol (SMTP) and it is within the scope of the knowledge supplied by an experienced programmer.

The application server 26 is where the various modules of the credit/debt management advising system reside. The modules include the various coaching engines, the Risk Evaluator and the portfolio modeling sub-systems. The applications may be implemented in many programming languages, including the object oriented programming languages such as C++ or Java™ And may be based on any platform such as UNIX™, Apple OS™ or Windows™ and NT™ Furthermore, the coaching engine rules for various coaching engine can reside on a data server 28. The Data server 28 stores user input data and supplies the application Server 26. The data server 28 includes outside database sources from which the credit/debt management advising system 18 can draw information such as actuarial data such as manual data input or public credit data from sources such as Experian™, Equifax™, Transunion™.

It should be noted that various computing platforms could be used to access the credit/debt management system of the present invention. For example, a networked personal computer environment, a client-server system, a mainframe terminal environment, WEB TV terminal environment, dumb terminal environments can be used to access the credit/debt management system of the present invention. Depending upon the user's needs, a client-server system (the web servers) may be the most preferable computing system for implementing the credit/debt management system of the present invention. Furthermore, the representation of each server such as an application server or a data server is a logical representation. The actual physical systems may be distributed over many servers, or be included on a single machine.

The management is handled in the exact same format as noted above for the credit & debt advisor since they collaborate in the same module.

FIG. 3 represents a box diagram of the data flow of a credit/debt management advisor system 18 of the present invention. A user using for example the user computer 14, preferably connects to the credit/debt management advisor system 18 over the wide area network 04. After authentication by a firewall server, the user at a user terminal 14 enters the credit/debt management advisor system 18 at the service level subsystem 60. The service level agreement provides the level of services to which the user is entitled. Once the user has negotiated a service level agreement 61, he is prompted to select the model to be used in operation 62. In one embodiment of the present invention, the level of service and support selected in the service level agreement 61 controls the user's access to different modeling tools.

In a preferred embodiment of the present invention the risk evaluator model may be the hub of the credit/debt management entity relationship. The risk evaluator model provides data to all coaching engines allowing customized coaching output to be dispensed to the user based on his unique credit/debt situation. The credit/debt management model combines all the pertinent credit/debt management information about a user in one coherent and comprehensive picture and models the user's long term intentions into an aggregated management system over a user selected period of time. Using the risk evaluator the user inputs his goal oriented intentions in terms of projected debt/lending needs. The risk evaluator model maintains an interactive dialog between the user and credit/debt management system. The risk evaluator model integrates the credit/debt management information available about the user in accordance with the user's service level agreement to create an aggregate forecast of estimated credit score/debt goals over the user's lifetime to ultimately eliminate all debt and sustain excellent credit still consciously allowing the user to live the targeted life they feel fit. The credit/debt management information available about the user includes the user's credit/debt management intentions data 66 and the user's current credit/debt management data 68. In a preferred embodiment of the present invention, the user's external credit/debt management data can include added accounts the system could not pull through public data credit vendors such as insurance premiums, property tax, miscellaneous fees, etc and information from the uses public credit/debt management data provided by all three of the major credit vendors/whichever service the system deems satisfactory to retrieve sufficient data. By incorporating external data 68 into the risk evaluator model 64, the system is capable of dynamically analyzing the credit/debt management needs of the user and providing the user with an understanding of their credit/debt management health at any point with minimal input from the user. As discussed above, personalized service level agreement 61 can optionally allow the user to limit the system's and/or advisor's access to the user's external credit/debt management data 68 or 66. After this process is completed the system will then route to the automated counsel 09.

Additionally, the risk evaluator model 64 also integrates external credit public data into the aggregated forecast of the user's credibility standing. In one embodiment of the present invention; access to both internal and external databases is controlled by the user's service level agreement.

The availability of the portfolio modeling tool is based on the user's service level agreement 61. The user would supply his credit/debt management portfolio information to the application server 26, either directly using the user terminal 14 or indirectly through the wide area network 04, by accessing a multiplicity of databases.

A credit/debt management portfolio modeling tool, is an interactive tool that has access to all the information available to the risk evaluator mode, such as the user's goal intentions data 66, the user's external credit & debt data 68. As a result the user has little to input and may start using the portfolio model very quickly without the need to do a lot of tedious data input since our vendors will input the majority of data automatically after credit data is pulled, etc. The credit/debt management portfolio modeling also allows the user to access a computer counsel and/or a live consultant based in part on the service level agreement. An alternative embodiment allows the user to use the risk evaluator model and set his long term credit/debt management goals such as the input of a specific credit grade or a debt balance and then use the credit portfolio modeling tool to adjust his credit/debt management portfolio to better counsel his long term credit/debt management goals this system does helps the user to mainly eliminate negative credit/reduce debt to better achieve these goals by licensed credit/debt management specialist.

The credit/debt management interactive model may capture the customer's intentions at the start of the introduction page and display them as aimed credit/debt management goals. Customer data and risk evaluator information combine to form a deep understanding of the customer's credit/debt management needs at each stage of the goal divided into monthly segments. Using dynamic, interactive multimedia, it quickly captures the customer's intentions and expectations about an ideal future. It also supports estimating the health value of the customer and the appropriate levels of services needed by grade. The data from this model combines with insight from product and transaction history as well as real time input from the abundance of interactive models to power rule-based coaching engines. This automated counsel leverages the advisor's time so that a broad customer based can be profitably supported. Configured using sliders; and other interactive controls. The controls build a linear graphic representation of a credit/debt management health meter which models predictable credit/debt management transitions over time more with the help of data-driven calculators and estimates a stage if instructions are followed correctly where client will be within 100% health and honor roll status grading, this stage would constitute a stage based on the clients credit and debt management that would open nearly any type of credit account they desire solely based on their credit history and debt management expertise we have created for them excluding income requirements which is irrelevant to our system since it is a different category all together. This health meter will also calculate an estimated range of improvement the client's credit score would inhibit based on common consumer used credit scoring engines currently on the market e.g. If this inquiry is removed your score will increase by 1-2%, since it would be impossible for us to give the client accurate scoring engine readings based on the secrets they hold within their grip we can base it off of expert reviews of credit removal of one inquiry based off of statistical age and user credit experience level determine by comparables that have experienced increases in their credit by 1-2% by removing one inquiry which would most likely justify this client will have the same result which is 98% accurate since 1-2% is a big range off of let's say a 600 credit score that is a total of 6 to 12 points. The key here is to help the client improve the credit and properly manage debt unlike most companies who will try to get the score temporarily up to obtain financing and be stuck in the same boat later down the line since they do not educate the client on things that need to be done to permanently keep the credit up so that our society can avoid predatory lending that puts millions of families around the world in hardship.

In addition to providing coaching to the user the system may also help the user to consider product solutions. As an example, in one embodiment of the present invention, the coaching engine may help the user consider and include deposit products and loan products in their credit/debt management plan. For example, the consultant engine may help the user consider acquiring a certain form of debt to assist the user in the reduction of another debt.

Depending on the level of service the user has negotiated with the service level agreement, he may have multiple modeling tools available in the credit/debt management system. In alternative embodiments of the present invention, modeling tools for analyzing and aiming toward various credit/debt management goals the user will take to assist him in his credit/debt management goals.

After the service level agreement has been negotiated, the user makes a first pass through the risk evaluator model. In one embodiment of the present invention, the user may input its goal intentions in terms of debt reduction intentions and credit stature intentions with advice on options to reduce debt and increase credibility then aggregates the information into a risk analysis over a user's over all intentions that will estimate the peak or the users credibility margin in a 48 months segment and the peak of the users debt in a maximum of a 360 month segment. The model may also include external data related to the user's added debt liabilities that will assist us in the overall true prediction verse the public data report. After a first pass through the risk evaluator, the system may estimate the probable customer profitability based on the user's credit/debt management plan given the user's goal intentions and other credit/debt management information. If the user's service level agreement does not match the probable goal the user can renegotiate the service level agreement or revisit the risk evaluation model to modify the model parameters based off of credit/debt management data, and then prompt the system to re-estimate the probable user goals.

In one embodiment of the invention, the risk evaluation model is followed by an executive activity process where the system allows the user to assume a decision-making role in making their credit/debt management future and portfolio. The activity process enhances the user's ability to manage his or her credit/debt management health from an executive perspective. For example, through interaction with the system, the user learns, plans, or decides the respective elements of their credit/debt management plan. The user may use the risk evaluation model to change input variables such as additional debt, additional credit accounts with a late/paid, and observe the long term effect of the changes on his credit/debt management goals and health. The intuitive graphical display of the risk evaluator model allows the user to get an immediate qualitative as well as quantitative feedback of the effects of the incremental changes on his long term goals. After engaging in these activities, the user may choose to initiate a transaction based upon the advice generated by the system. In alternative embodiments of the present invention, both the automated coaching and the live consultations may recommend various credit/debt management links to products suitable to the user's credit/debt management situation that they may qualify for to reduce payments immediately such as a home equity line of credit to pay off current high credit card debt. Furthermore, after initiating the transaction, the user may monitor and/or manage the credit via a service solution we are provided through a partnership credit reporting vendor that will monitor/alert the consumer if any new information is to appear on their credit. In one embodiment of the present invention, the learn icon allows the user to obtain information on the products recommended by the automated coaching engine or the live consultants. The system may have to access outside databases to access third party products which may be beneficial to the user's credit/debt situation. The rule based coaching further may check the governmental regulations and impacts of adding or deleting a specific product to the user's credit/debt management portfolio. The governmental regulations analyzed can include an analysis of the tax consequences of using a certain product specific to the user verse another to possibly save money on income which would be more money to be used to pay down debt.

After fine tuning the risk evaluating model, context sensitive automated computer coaching is provided to the user using a coaching engine based on the statistic logic rule-based engine we have designed that will cover the most probable results based on experience and expertise in the field of credit & debt consultation that will grade clients as a teacher would grade his student in the range of A, B, C, D, F and explain to the user the probable difference in ranges their score would be on or about with each grade so they have a better idea were their FICO™ or any other consumer related similar score would be to have a better understanding of where there current chances of obtaining a particular loan would be. Since most credit scoring engines are designed under similar “by laws” our systems will be able to clearly identify accurately; over 90% probable chances of being right since our systems will be more strict in grading then the popular systems used in scoring to ensure the chances are higher based on our systems calculation that the borrower will obtain the credit desire. E.g grade A would allow the client any form of financing that the client can financially afford, our Grade A will imply to the client under no circumstances will the under writer have a judgment against the clients credit in relations to their underwriting decisions there for doing our duty and creating an A student. The user has the option to continue to be an A student as long as he/she follows our methods. The rules repository supplies statistical common credit rules that would be considered common sense to a credit expert in understanding the negative verse the positives of a credit file and do not constitute in any manner a usage of a patented credit scoring engine, since that credit scoring engine goes off of the same public data we go off of but is used in a different format there for eliminating infringement under the doctrine of equivalents “Determine whether the accused device or process operates in substantially the same way as the claimed invention”, which it doesn't. The automated coaching engine may highlight for the user periods within his risk evaluation model which need special attention, such as a projected debt deficit based on the habits of the clients payment history. Based on the coaching from the automated consulting engine and/or a live advisor, the user may accept or reject the risk evaluation model. If the user rejects the risk evaluation model, they may further modify and fine tune the risk evaluation model until he is satisfied with his risk level. The credit grading system will range predicted popular scoring engine scores such as Grade A meaning a credit score range possibly of 700 or above, Grade B a credit score ranging possibly between 640-699, Grade C score a credit score ranging 600-639, Grade D a credit score ranging 540-599, Grade F a credit score range 540 or below which are estimates of scoring engines commonly used to eliminate the client wasting tons of money to re pull their credit to see where the score is and instead allowing us to ultimately repair it so the user can reach his/her credit/debt management intentions. If the user maintains an A grade for more than one year we will post them to an honor roll we feel this form of psychology influences people to keep their credit/debt management in good order since they have accomplished something and will influence them to continue to maintain good credit so their honor status is not terminated.

### CONCLUSION

This product will help every individual that is currently living in the United States Of America by educating them on how to understand their credit report and the impact it has in everyday life; and to avoid focusing on a score which is used to target programs that can still require additional repairs to the credit data such as a collection filed that must be cleared before a mortgage loan is funded even thought the Fico™ score qualified the user for the loan. We teach the user the true fundamentals of their credit report so they understand why the underwriters judge them in the manner they do. We show the user how to avoid costly mistakes and teach them one of the most important things they will need to know without a substantial amount of net worth; their credit health; and in return how it plays a great impact on the way they manage their debt. Thank you for your time in reading this.

What is claimed is:

1. A method for providing online automated web-based credit & debt management counseling over the internet comprising: providing a plurality of unique packages, each including a unique combination of available computer consulting and live consulting, the live consulting being performed by an employee/independent contractor; developing a service agreement with a user for a desired service level of credit/debt management counseling; receive from the user a desired service level selected from the plurality of available unique service levels listed; grade credit/debt management risk levels via a credit/debt management risk evaluator that will determine the health levels that will in return generate automated credit/debt management counseling to further context and individualize sensitive automated credit/debt related computer consulting information to the user using a coaching engine based on the statistical logic rule-based engine and credit/debt management common studies defining a negative from a positive off of public data credit reports or manual user input of general debt data that will predict the most probable grade decision based on computer automated system data inputted by someone trained in the arts of credit/debt management/consulting; risk tolerance levels based on a letter grading system (A, B, C, D, F); suggest how to improve topics in relations to credit/debt management matters based on the data provided to the system whether by third party credit vendor or manually inputted by the user. Negotiate fees to be charged to the user based upon package level the user has decided to go with that may be revised during the relationship. Automatically analyze and individualize the credit/debt management needs of the user; including but not limited to identifying all of the negative items that can impact users credit or debt management stability; Remind user to pay debts by email alert on a monthly basis for acknowledged debts registered with system.

2. The method of claim 1 where in the service level agreement includes a determination of access is based on one account per user.

3. The method of claim 1 wherein the credit/debt management model includes developing a user's credit/debt management risk portfolio and grading it in letter format.

4. The method of claim 3 wherein developing a user's credit/debt management risk level comprises: determining the credit goals of the user and the user's risk tolerance; determining the current credit/debt management stature and position of a user; and suggesting methods to develop new positions for the user to improve stature.

5. The user computer system of claim 1, including an advanced algorithm to direct the user to use computer consulting prior to using live consulting, if the service level is below a threshold.

6. The method of claim 1 wherein said automated consulting may dispense general/individual; credit/debt management consulting based on the user's credit history displayed on the user's personal credit report/the user's manual input.

7. The method of claim 5 wherein said live consulting may dispense specific credit/debt management consulting based on the user's credit model/report.

8. The consulting computer system of claim 5 where in the system includes: a user interface for computer consulting to dispense general/specific credit/debt management advice based on the user's credit data findings.

9. The live counselor system of claim 7, further comprising: a user interface for live consulting to dispense specific credit/debt management advice based on the user's credit/debt management model.

10. The computer program of claim 9 for developing a credit model, further comprising: developing the user's credit/debt management portfolio.

11. The computer program of claim 10, further comprising: determining the credit/debt management goals of the user and the user's risk tolerance; determining the current credit/debt position of the user by grade level and individualizing improvement strategies for both.

12. The computer program of claim 11 wherein the automated coaching further comprises: computer coaching to dispense specific credit/debt management advice based on the user's credit/debt management model.

13. The computer program of claim 9 wherein the live counseling further comprises: computer coaching to dispense specific credit/debt management advice based on the user's credit model.

14. The computer programming of claim 1 wherein the automated system will be programmed to locate derogatory items based off of a data search scan that analyzes with careful analysis and common knowledge a negative vs. positive that would be noticeable to somebody skilled in the arts of credit/debt management/counseling.

15. The computer programming of claim 13 & 14 suggesting new credit/debt management positions for the user with general/individual advice on how to reach this goal.

16. The computer programming of claim 1 suggesting monthly reminder alerts further comprises: a monthly automated reminder alert to alert the user of any open accounts that reports on credit data or that have been manually inputted by the user that we have on file to pay their bills before it impacts their credit score via email with a list of accounts that are to be paid that are currently listed open to the systems knowledge.

17. The computer programming of claim 1 data comprises: manual user input of general debt data which shall consist of the date debt was opened, the current balance to date, the original balance, the amount of late payments consisting of a minimum of 30 and maximum of 90 days late each payment in a sequence of 30, 60, 90, the amount of times late & the specific months late as well as debt type. Example: revolving, mortgage, etc.
